(19) United States
(12) Patent Application Publication
(10) Pub. No.: US 2018/0309275 A1
(43) Pub. Date: Oct. 25, 2018

(54) Bendable Tray Section

(71) Applicant: WBT, LLC, Belleville, IL (US)

(72) Inventor: Richard Gregg Winn, Belleville, IL (US)

(73) Assignee: WBT, LLC, Belleville, IL (US)

(21) Appl. No.: 15/491,724

(22) Filed: Apr. 19, 2017

(51) Int. Cl. H02G 3/04; B21D 11/10

(52) U.S. Cl. CPC H02G 3/0456; B21D 11/10

(57) ABSTRACT

A cable tray accessory section that is manually bendable allowing it to easily bend over or under obstructions, such as ceiling beams and pipes. The bendable cable tray comprises a plurality of cross members combined by first and second longitudinal side members. The cross members are not combined by any other means thereby allowing the first and second longitudinal members to be easily bent in the field by the user to a desired configuration. The bendable cable tray section is adapted to connect at each end to another cable tray or accessory section. In some embodiments the bendable tray section starts with one end at a particular elevation, bends over or under an obstruction, then returns the second end to the original elevation. In other embodiments the bendable tray section starts with one end at a particular elevation then bends along its length (typically upward or downward) so that the second end is positioned at a different elevation.

### BACKGROUND

This invention relates generally to cable tray systems used to support electrical wiring, cables, conduit and data transmission lines (collectively “cables”), and more particularly to junctions which connect two or more cable tray sections or accessories.

Cable trays systems generally provide support for cables as the cables extend from a first location to a second location. Cable tray systems can be comprised of metal, plastic, or other suitable types of materials. One exemplary type of cable tray is referred to as a “mesh” or “basket” cable tray. These types of cable trays are comprised of interconnected members such as metal bars or wires. Most mesh cable trays include space apart U-shaped cross members which are connected by lateral support members along the sides and bottom of the cross members. The cross members are generally perpendicular to the longitudinal axis of the cable tray. The cables are generally supported by the bottom portion of the cross members as the cable tray system carries the cable from one point to another point.

Most cable trays are adapted to join with one or more other cable trays at intersections such as T-intersections or four-way intersections to create the cable tray system. Further, sometimes a radius or bend section is necessary to allow a single cable tray to turn a corner or change elevation. Other accessories used to connect portions of a cable tray system include reduces, benders, risers, and cross pieces. Collectively, these various accessories are sometimes referred to herein as “accessory sections.”

Most mesh or basket cable trays are designed to be field configured out of straight sections, meaning very few accessory sections exist to bend around corners or change elevations. The few that do are bulky and expensive to ship because they are created as a single section at the factory, and difficult to assemble/install.

Another problem with typical cable tray sections is that they are difficult to install when ceiling beams, pipes, and other obstructions are present. While the prior art describes the use of a “ladder” system that can be installed in a stair-step manner to get around such obstructions, the sections are rigid and of a predetermined length, and therefore cannot be easily configured to get around obstructions or change elevations. There is therefore a need in the art for a cable tray apparatus which overcomes these and other deficiencies in the prior art.

### SUMMARY

The present invention relates to an improved cable tray accessory section that is bendable allowing it to easily bend over or under obstructions, such as ceiling beams and pipes. The bendable cable tray comprises a plurality of cross members combined by first and second longitudinal side members. The cross members are not combined by any other means thereby allowing the first and second longitudinal members to be easily bent in the field by the user to a desired configuration. In some embodiments the cross members are “U” or “V” shaped. The bendable cable tray section is adapted to connect on each end to another cable tray or accessory section. In one embodiment the bendable cable tray has a first end combined with a first cable tray and a second end combined with a second cable tray. In some embodiments the bendable tray section starts with one end at a particular elevation, bends over or under an obstruction, then returns the second end to the original elevation. In other embodiments the bendable tray section starts with one end at a particular elevation then bends along its length (typically upward or downward) so that the second end is positioned at a different elevation.

The longitudinal side members are preferably made of any suitable material that allows for easy bending yet remains in the bent position after bending. In one embodiment the side members are made from a malleable metal that can be bent by hand such as low carbon steel wire. The steel wire may be galvanized, stainless, or powder coated.

Another aspect of the invention relates to a method of using the cable tray accessory section described above. The method includes taking a bendable tray section which has a plurality of cross members combined only by a first longitudinal member and a second longitudinal member. The first and second longitudinal members are manually bent to create a first corner wherein a first portion of the bendable tray section is angled relative to a second portion of the bendable tray section. The first and second longitudinal members are further bent to create a second corner wherein the second portion of the bendable tray section is angled relative to a third portion of the bendable tray section. The method further includes securing the first portion of the bendable tray section to a first cable tray section and the third portion of the bendable tray section to a second cable tray section.

Another aspect of the invention relates to a method of manufacturing the cable tray accessory section described above. The method includes connecting a first longitudinal side member with a second longitudinal side member using a plurality of cross member. The cross members may include a bottom member having a first side member extending from one end and a second side member extending from the other end to form a generally “U” or “V” shape. The side members have a first end combined with the bottom member and a second end combined with one of the longitudinal side members. In one embodiment the side members extend from the bottom member in the same direction at an angle of between 70 and 110 degrees. In another embodiment the side members extend from the bottom member in the same direction at about 90 degrees. The side walls created by this depth helps retain the cables within the tray.

### BRIEF DESCRIPTION OF THE DRAWINGS

FIG. 1 is a perspective view of a bendable tray section;

FIG. 2 is a perspective view of a bendable tray section with a first end bent to combine with a horizontal cable tray at a first elevation and a second end bent to combine with a horizontal cable tray at a second elevation.

FIG. 3 is a perspective view showing the bendable tray section similar to the one shown in FIG. 2 and further showing fasteners for securing the bendable tray section to the first and second horizontal cable trays.

FIG. 4 is a side view of a bendable tray section overpassing a beam and connected to cable trays at each end.

### DETAILED DESCRIPTION

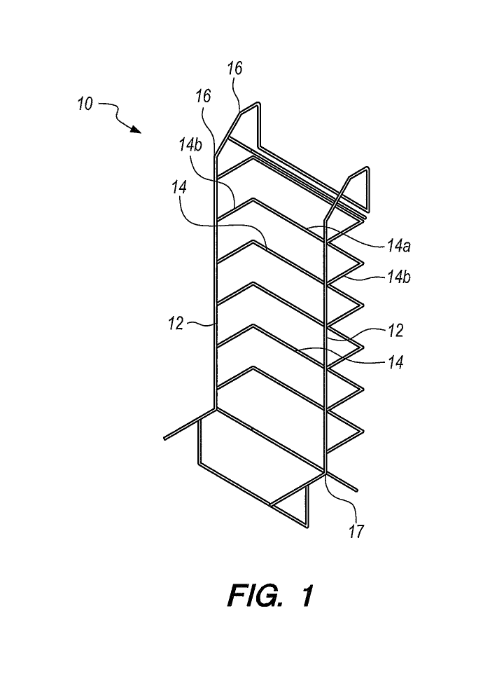

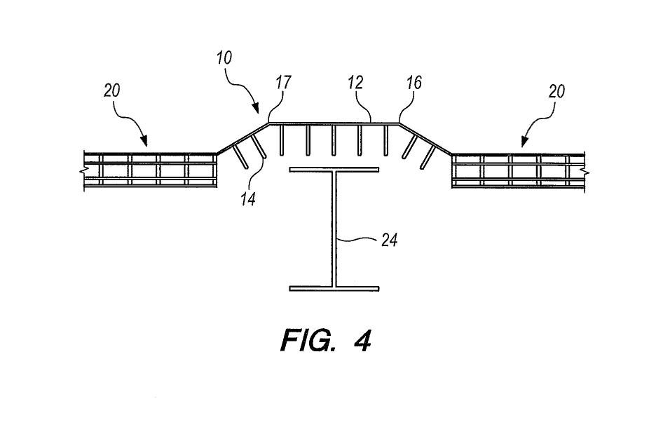

As shown generally in FIGS. 1-4, the present invention comprises a bendable tray section 10 for connecting to one or more cable tray sections 20 or other accessory sections of a cable tray system. As shown, the cable tray section 10 generally comprises a wire frame having a first longitudinal side member 12 and a second longitudinal side member 12 combined by a plurality of cross members 14. The longitudinal side members are bendable along their length to create a vertical offset so that one end of the bendable tray section 10 may be at a different elevation than the other end as shown in FIGS. 1-3. Or, as shown in FIG. 4, a middle portion of the bendable tray section 10 may be at a different elevation than both ends. The bendable tray section 10 helps support and guide cables to and from their intended locations.

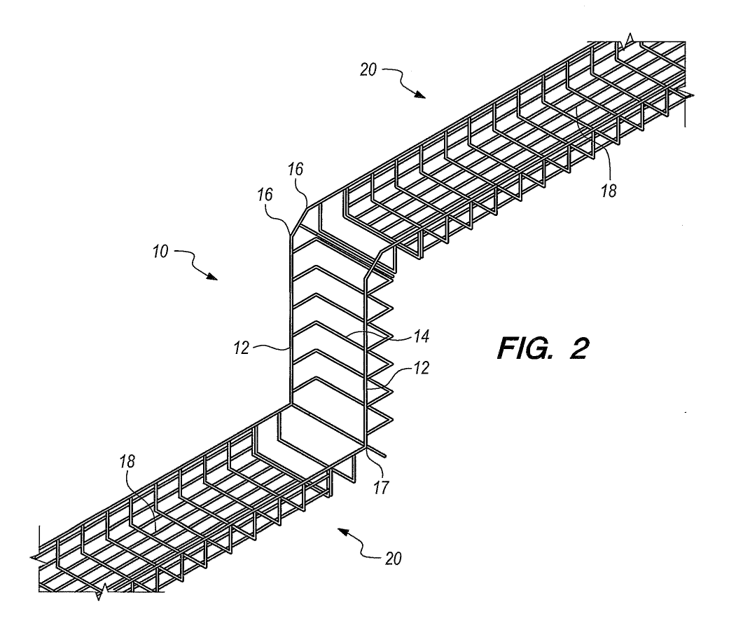

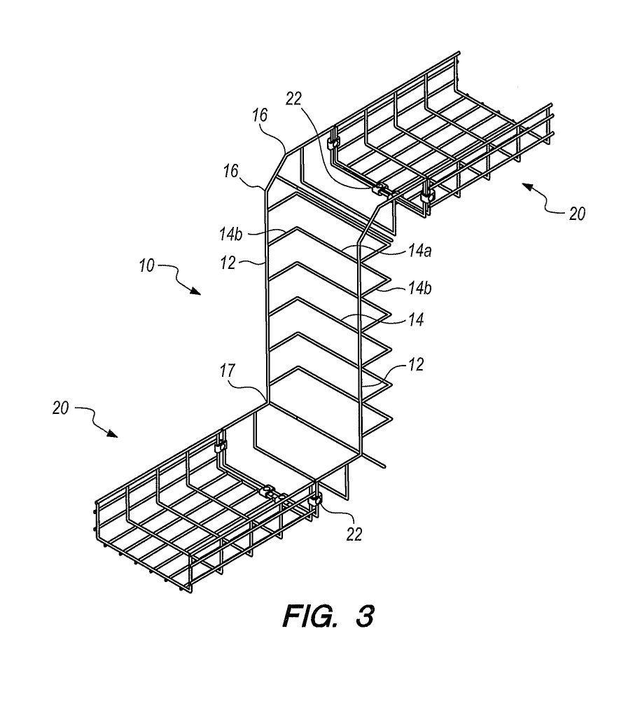

In order to allow the bending of the longitudinal side members 12, the bendable cable tray section 10 does not include any longitudinal supports that run parallel with the sidewalls 12 at the areas where bending may occur, such as the corners 16 shown in the figures. In other words, the bendable tray section 10 does not include any members that connect the cross members 14 except for the two side members 12. This allows the cross member 14 to easily move relative to each other as the assembly is bent at desired locations along the longitudinal side members 12. For example, FIGS. 1 and 3 show the longitudinal side members 12 have been bent at corner 16 near the top of the tray section 10 causing the cross members 14 to be closer together. This bend transitions section 10 from a generally horizontal orientation downward to a generally vertical orientation. Likewise, the longitudinal cross members 14 have been bent at corner 17 near the bottom of the bendable tray section 10 causing the cross members 14 to be farther apart. This bend transitions tray section 10 from a generally vertical orientation to a generally horizontal orientation. It can be imagined that traditional mesh cable tray sections, like tray sections 20 shown in FIGS. 2 and 3, are not capable of bending because the plurality of longitudinal members connecting the cross members would prevent such movement.

In the embodiment shown, the cross members 14 are generally “U” or “V” shaped. In other words, the cross members 14 include a bottom member 14a extending across a width and a side member 14b extending outward from each end of the bottom member 14a to provide some depth to the tray section 10. The side members 14b have a first end combined with the bottom member 14a and a second end combined with one of the longitudinal side members 12. In one embodiment the side members 14b extend from the bottom member 14a in the same direction at an angle of between 70 and 110 degrees. In the embodiments shown the side members 14b extend from the bottom member 14a in the same direction at about 90 degrees. The side walls created by this depth helps retain the cables within the tray.

As shown in FIGS. 2 and 3, the bendable cable tray section 10 is combined at each end with a cable tray 20 or other type of accessory section.

The longitudinal side members 12 of the bendable tray section 10 may be made of any suitable bendable material including meals and plastics. In one embodiment the material is rigid and malleable with minimal elasticity. The material may be a low carbon steel wire, which may be galvanized, stainless, or powder coated. The malleability is such so that a user can bend the side members 12 by hand and the elasticity is such so that once bent, the side member 12 remains in the bend position. This allows the side wall 12 to be easily bent by the user to a desired angle without returning to their original position after force is removed. The bendable tray section 10 is easily configured in the field to the appropriate shape without the need for any tools, cutting, or pre-fabrication.

In some embodiments, the bendable tray includes a means for connecting the bendable tray to the cable tray sections. In the embodiment shown in FIG. 3, the bendable tray section 10 is connected to other cable tray sections 20 or accessories at one or both of its ends by a fastener 22, such as the connecting clips or splice kits that are known in the art. It should be noted that it is not necessary to support the bendable tray section 10 from above or below by a post, wire, or other supporting member as long as the ends are securely fastened to the adjacent cable tray sections 20 or accessory sections. In this embodiment the connection at the end(s) of the bendable tray 10 to other cable tray sections 20 is its only connection/support.

Another aspect of the invention relates to a method of using the bendable cable tray section 10 described above. The method comprises manually bending the bendable cable tray section 10 to a desired angular configuration then connecting one or both of its ends to another portion of the cable tray system, such as a cable tray 20 or an accessory section. In one embodiment, a user manually bends a first portion of the bendable cable try section 10 to create corners 16 (this is shown as two corners to make the ninety degree bend) a predetermined distance from a first end of the bendable cable tray section 10. This create a first portion of the bendable cable tray section 10 that is generally horizontal and a second portion of the bendable cable tray section 10 extending at some angle relative to the first portion. In the embodiment shown in FIG. 3, the bend in the bendable cable tray section 10 is about ninety degrees thereby allowing the first portion of the bendable cable tray section 10 to be generally horizontal and the second portion to be generally vertical. The user then manually bends another portion of the cable tray section to create corners 17 a predetermined distance from the second end of the bendable cable tray section 10. This creates a third portion of the bendable cable tray section extending at some angle relative to the second portion. In the embodiment shown in FIG. 3, the third portion of the second bend is about ninety degrees thereby allowing the third portion to be generally horizontal. In some embodiments the method further comprises attaching the ends of the bendable cable tray section 10 to adjacent cable tray sections 20 or accessory sections using fasteners.

FIG. 4 shows an alternate embodiment wherein the user makes at least three bends in the section 20 and the bends/corners 16, 17 are less than ninety degrees. It should be appreciated that any number of bends may be used to configure the bendable cable tray section 10.

Another aspect of the invention relates to a method of manufacturing the cable tray accessory section described above. The method includes connecting a first longitudinal side member 12 with a second longitudinal side member 12 using a plurality of cross member 14. The cross members 14 may include a bottom member 14a having a first side member 14b at one end and a second side member 14b at the other end to form a generally “U” or “V” shape. The side members 14b have a first end combined with the bottom member 14a and a second end combined with one of the longitudinal side members 12. In one embodiment the side members 14b extend from the bottom member 14a in the same direction at an angle of between 70 and 110 degrees. In another embodiment the side members 14b extend from the bottom member 14a in the same direction at about 90 degrees. The side walls created by this depth helps retain the cables within the tray.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

1. A bendable tray section having a first end and a second end, said bendable tray section comprising:
a first longitudinal member extending generally parallel to a second longitudinal member;
a plurality of cross members, each cross member having a first end combined with the first longitudinal member and a second end combined with the second longitudinal member, wherein the first longitudinal member and the second longitudinal member are the only members connecting the plurality of cross members;
a first corner along the first and second longitudinal members wherein a first portion of the bendable tray section is angled relative to a second portion of the bendable tray section;
wherein the bendable tray section first end is adapted to be combined with a first cable tray or cable tray accessory section and the bendable tray section second end is adapted to be combined with a second cable tray or cable tray accessory section.

2. The bendable tray section of claim 1 wherein each of the plurality of cross members is U-shaped.

3. The bendable tray section of claim 1 wherein each of the plurality of cross members includes a bottom member having a first end and a second end, a first side member extending from the first end of the bottom member, and a second side member extending from the second end of the bottom member.

4. The bendable tray section of claim 3 wherein the first longitudinal member is combined with the first side member of each of the plurality of cross members and the second longitudinal member is combined with the second side member of each of the plurality of cross members.

5. The bendable tray section of claim 1 further comprising fasteners for securing the bendable tray section to the first and second cable tray or cable tray accessory section.

6. The bendable tray section of claim 1 wherein the first cable tray and the second cable tray comprise a plurality of cross members combined by a plurality of longitudinal support members.

7. The bendable tray section of claim 1 wherein the first cable tray is positioned at a first elevation and the second cable tray is positioned at a second elevation.

8. The bendable tray section of claim 1 wherein the first and second longitudinal members are comprised of a malleable metal.

9. The bendable tray section of claim 1 wherein the first and second longitudinal members are comprised of a low carbon steel wire.

10. A bendable tray section having a first end and a second end, said bendable tray section comprising:
a first longitudinal member extending generally parallel to a second longitudinal member;
a plurality of cross members, each having a bottom member, a first side member, and a second side member, wherein the first side member is combined with the first longitudinal member and the second side member is combined with the second longitudinal member;
wherein the bottom members of the plurality of cross members are not combined with each other;
a first corner along the first and second longitudinal members wherein a first portion of the bendable tray section is angled relative to a second portion of the bendable tray section;
wherein the bendable tray section first end is adapted to be combined with a first cable tray or cable tray accessory section and the bendable tray section second end is adapted to be combined with a second cable tray or cable tray accessory section.

11. The bendable tray section of claim 10 wherein each of the plurality of cross members is U-shaped.

12. The bendable tray section of claim 10 further comprising fasteners for securing the bendable tray section to the first and second cable tray or cable tray accessory section.

13. The bendable tray section of claim 10 wherein the first cable tray and the second cable tray comprise a plurality of cross members combined by a plurality of longitudinal support members.

14. The bendable tray section of claim 10 wherein the first cable tray is positioned at a first elevation and the second cable tray is positioned at a second elevation.

15. The bendable tray section of claim 10 wherein the first and second longitudinal members are comprised of a malleable metal.

16. The bendable tray section of claim 10 wherein the first and second longitudinal members are comprised of a low carbon steel wire.

17. A method of using a bendable tray section comprising:
taking a bendable tray section having a plurality of cross members combined only by a first longitudinal member and a second longitudinal member;
manually bending the first longitudinal member and the second longitudinal member to create a first corner wherein a first portion of the bendable tray section is angled relative to a second portion of the bendable tray section;
manually bending the first longitudinal member and the second longitudinal member to create a second corner wherein the second portion of the bendable tray section is angled relative to a third portion of the bendable tray section;
securing the first portion of the bendable tray section to a first cable tray section and the third portion of the bendable tray section to a second cable tray section.

18. The method of claim 17 wherein the first corner creates a bend of about ninety degrees between the bendable tray section first portion and the bendable tray section second portion.

19. The method of claim 17 wherein the second corner creates a bend of about ninety degrees between the bendable tray section second portion and the bendable tray section third portion.

20. The bendable tray section of claim 10 further comprising a second corner along the first and second longitudinal members wherein the second portion of the bendable tray section is angled relative to a third portion of the bendable tray section.
